(19) United States
(12) Patent Application Publication
(10) Pub. No.: US 2002/0176330 A1
(43) Pub. Date: Nov. 28, 2002

(54) Headset with data disk player and display

(76) Inventors: Gregory Ramonowski, Schenectady, NY (US); Roland Ramonowski, Schenectady, NY (US)

Correspondence Address: HOFFMAN WARNICK & D'ALESSANDRO, LLC, 3 E-COMM SQUARE, ALBANY, NY, 12207

(21) Appl. No.: 10/083,947

(22) Filed: Feb. 27, 2002

Related U.S. Application Data
(63) Continuation-in-part of application No. 09/863,112, filed on May 22, 2001.

(51) Int. Cl. G11B 7/085

(52) U.S. Cl. 369/30.36

(57) ABSTRACT

A headset with a data disk player. The headset includes a head assembly for securing to the head of a user, a display coupled to the head assembly, and a data disk reader coupled to the head assembly and in communication with the display.

### REFERENCE TO PRIOR APPLICATION

This application is a continuation-in-part application of U.S. Ser. No. 09/863,112, filed May 22, 2001, and currently pending.

### BACKGROUND OF THE INVENTION

1. Technical Field

The present invention relates generally to a portable data disk player, and more particularly, to a headset with a data disk reader coupled to it. Alternative aspects provide for the headset further having a speaker and/or a display coupled thereto.

2. Background Art

A. Compact Disk Players

Portable compact disk players are favored mechanisms for listening to audio such as music while walking, running or doing any other sort of activity that requires movement. The typical compact disk player reads information from a compact disk, a mini disk and other forms of data storage devices. The players are typically compact and portable/hand-held.

The body of a portable compact disk player is usually made from a mold that is tooled and/or shaped to correspond to the size that is needed to encompass the elements for the electronic parts and the compact disk. The materials used to make the body of the compact disk are usually a form of polyurethane, polyethylene or the like. The body is made to be light, strong and resistant to elements like moisture, sweat and dirt.

Unfortunately, currently available compact disk players suffer from a number of disadvantages. For instance, when using existing players, it is necessary to have a set of headphones with wires attached to a separate compact disk player to hear the music. The wires dangle and constantly interfere with movement while doing any activity requiring motion. The dangling wires are also unsafe when participating in any activity requiring movement. It is very easy for the wire to get entangled around a stationary object and place the user in danger.

Another disadvantage of currently available compact disk players is that the compact disk player has to be carried. While participating in any activity requiring movement, it is beneficial to have the hands free of any object.

Another disadvantage of currently available compact disk players is that the player has to be held or attached to the body by a clip of some sort. The player can be destroyed by accidently dropping it or from the clip breaking, having the player drop to the ground.

B. Video Disk Players

Video data disk players are favored mechanisms for watching video such as rented movies, family activities or for playing video games. The typical video data disk player reads information from a compact disk, a mini disk and other forms of data storage devices. For example, common video data storage devices include Digital Versatile Disc (DVD), Data Play disc, etc. The players are typically large, stationary pieces of electronic equipment placed within a living quarters.

The body of a video data disk player is usually made from a mold that is tooled and/or shaped to a size that is needed to encompass the elements for the electronic parts and the video data disk. A typical video data disk player is made to be strong and resistant to elements like moisture, heat and dust.

Unfortunately, currently available video data disk players suffer from a number of disadvantages. For instance, when using existing players, it is frequently necessary to watch the video using an external device, such as a television or monitor. Use of two devices generally requires one or more wires to allow communications between the devices. Additionally, existing players and monitors generally require an alternating current outlet to operate and are relatively large in size. Due to these limitations, it is practically impossible for an individual to easily move the devices for portable operation.

Another disadvantage of existing players is the necessity to purchase additional, frequently expensive, equipment for video gaming. In order to, for example, play video data disc games, specialized video game equipment is required and is an added expense to the user.

In view of the foregoing, there is a need for a headset having a data disk reader coupled to it. Further, there is a need for the headset to have a speaker and/or a display coupled thereto.

### SUMMARY OF THE INVENTION

The current invention provides a headset having a data disk reader coupled to it. In one aspect, the headset also has a speaker coupled thereto. In another aspect, a display is further coupled to the headset.

A first aspect of the invention provides a headset comprising: a head assembly for securing to the head of a user; a display coupled to the head assembly; and a data disk reader coupled to the head assembly and in communication with the display.

A second aspect of the invention provides a headset comprising: a head assembly for securing to the head of a user, the head assembly including a first housing, a second housing, and a display housing; a first speaker coupled to the first housing; a second speaker coupled to the second housing; a display coupled to the display housing; and a data disk reader coupled to the head assembly, wherein the data disk reader is in communication with the first speaker, the second speaker and the display.

A third aspect of the invention provides a headset comprising: a head assembly for securing to the head of a user, the head assembly including a first support for placing a first speaker next to a first ear of a user and a second support for placing second speaker next to a second ear of a user; a display coupled to the first support and the second support; and a data disk reader coupled to the head assembly, wherein the data disk reader is in communication with the first speaker, the second speaker and the display.

A fourth aspect of the invention provides a headset comprising: means for securing to a head of a user; means for reading a data disk coupled to the means for securing; and means for displaying data read by the means for reading coupled to the means for securing.

The exemplary aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 is a front view of a headset data disk player according to a first aspect of the invention;

FIG. 2 is a partial side view of the first aspect showing a first housing with a control panel coupled thereto;

FIG. 3 is another partial side view of the first aspect showing a second housing with a data disk reader coupled thereto;

FIG. 4 is a rear view of a second aspect of the invention;

FIG. 5 is a side view of a third aspect of the invention;

FIG. 6 shows a front view of a headset with a data disk player and display;

FIG. 7 shows a partial side view of a headset including a first housing;

FIG. 8 shows a partial side view of a second housing;

FIG. 9 shows a rear view of a headset with a data disk player and display;

FIG. 10 shows a side view of a headset with a data disk player and display;

FIG. 11 shows an alternate side view of the headset of FIG. 10; and

FIG. 12 shows a front view of the headset of FIG. 10.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

A. Headset Data Disk Player

Referring now specifically to the drawings, there is illustrated a headset 10 including a head assembly 11, a data disk reader 12, a control panel 14 for controlling operation of the data disk reader 12, a first housing 16, including a speaker 18, with control panel 14 coupled thereto, and a second housing 20, including a speaker 22, with data disk reader 12 coupled thereto.

As illustrated, headset 10 is portable and adapted to be secured to the head/neck area of a user. However, as will be recognized by those skilled in the art, the teachings of the invention are not to be limited to just portable data disk headset players. Additionally, while two speakers are illustrated, it should be recognized that a similar headset comprising a single speaker can also be used. Finally, it should be known that some or all of the housings described below are not required to implement the invention.

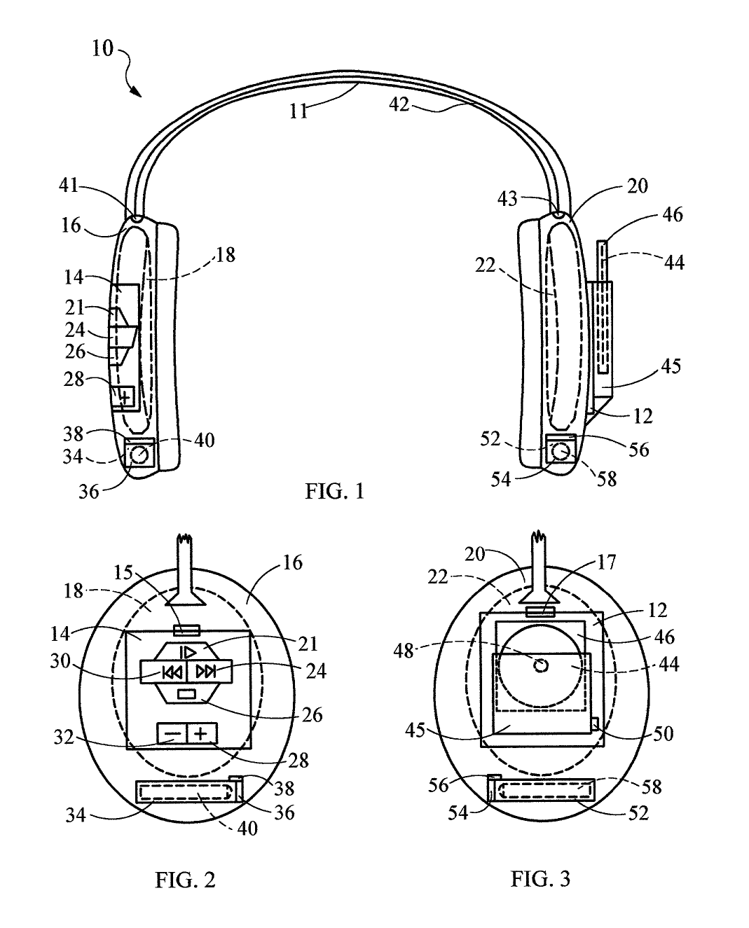

In a first embodiment, shown in FIGS. 1-3, control panel 14 is coupled to first housing 16 using a control panel coupler 15. It should be recognized that control panel 14 may be permanently or detachably coupled to head assembly 10, or housings 16 or 20. Numerous mechanisms for coupling control panel 14 are possible, including a slot, hinge, compartment, hook and latch fasteners, clips, glue, buttons, buckles, snaps, screws, etc. Control input devices 21, 24, 26, 28, 30 and 32 provide an interface for control panel 14 allowing a user to control the operation of data disk reader 12.

A power source housing 34 is shown located in first housing 16. A hinged door 36 may be provided to gain access to power source housing 34. As shown, hinged door 36 is attached to first housing 16 by a hinged fastener 38. It should be recognized, however, that other door mechanisms as known in the art are also possible with the invention, e.g., a retractable door system, detachable door, etc. Additionally, it should be recognized that power source housing 34 may be located in control panel 14. A power source 40 may be a dry cell type of power source but other power sources known in the art are also possible with the invention, e.g., corded adaptor plugins, solar cells, nuclear capsules, etc. Power source 40 is contained in power source housing 34.

Referring to FIG. 1, a first end 41 of head assembly 11 is coupled to first housing 16, and a second end 43 of head assembly 11 is coupled to second housing 20. Conductive material 42 is shown included within head assembly 11. Conductive material 42 is used to transmit data between the data disk reader 12, control panel 14 and speaker(s) 18, 22. Conductive material 42 may be comprised of copper wire, ceramic material, etc. Data disk reader 12 and control panel 14 can be either directly connected to conductive material 42, or conductive material 42 may be connected to similar conductive material within housings 16 and 20 which then connects to control panel 14, data disk reader 12, and speaker(s) 18, 22. While conductive material 42 is shown, it should be recognized, that other materials and transmitting devices as known in the art are also possible with the invention, e.g., infrared red sensors, fiber optics, lasers, etc.

Data disk reader 12 is shown coupled to second housing 20 using a reader coupler 17. It should be recognized that data disk reader 12 may be permanently or detachably coupled to head assembly 10, or housings 16 or 20. Numerous mechanisms for coupling data disk reader 12 are possible including a slot, hinge, compartment, hook and latch fastener, clips, glue, buttons, buckles, snaps, screws, etc. A data disk compartment 45, formed in a side of data disk reader 12, is provided. A data disk 44 (shown partially inserted) may be placed in a data disk holder 46. A positioning post 48 can be used to keep data disk 44 centralized. A locking tab 50 holds data disk holder 46 in place. When it is necessary to remove data disk holder 46 from data disk compartment 45, locking tab 50 maybe pressed and data disk holder 46 is released. It should be recognized, however, that other locking mechanisms as known in the art are also possible with the invention, e.g., a hinged or retractable door system may be used to secure and protect data disk 44 with or without data disk holder 46. A power source compartment 52 may be provided in second housing 20. A hinged door 54 may be provided to gain access to power source compartment 52. As shown, hinged door 54 is attached to second housing 20 by a hinged fastener 56. It should be recognized, however, that other door mechanisms as known in the art are also possible with the invention, e.g., a retractable door system, detachable door, etc. Additionally, it should be recognized that power source compartment 52 may be located on data disk reader 12. A power source 58 may be a dry cell type of power source but other power sources known in the art are also possible with the invention, e.g., corded adapter plugins, solar cells, nuclear capsules, etc. Power source 58 is contained in power source compartment 52.

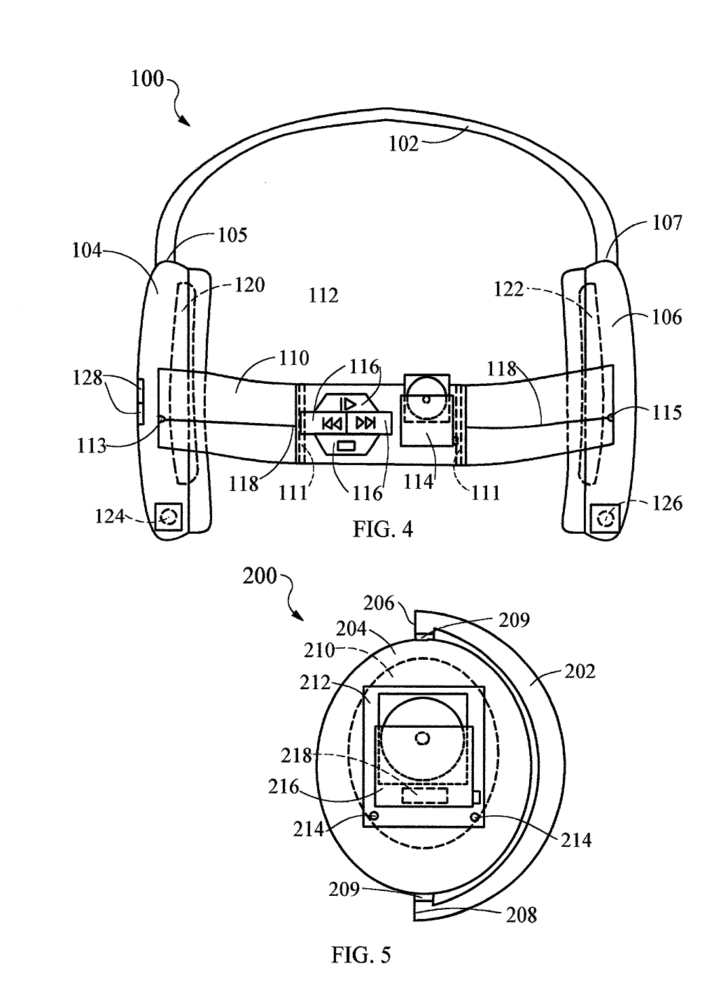

Referring to FIG. 4, a second embodiment of a headset 100 is disclosed. This embodiment includes: a first assembly 102, a first housing 104 coupled to a first end 105 of first assembly 102, a second housing 106 coupled to a second end 107 of first assembly 102 and a second assembly 110 with a first end 113 coupled to first housing 104 and a second end 115 coupled to second housing 106. A speaker 120 is located within first housing 104 and a speaker 122 maybe located within second housing 106. A panel 112 is shown coupled to second assembly 110 using a coupler 111. Panel 112 includes a data disk reader 114 and controls 116. However, data disk reader 114 and controls 116 may be placed on separate panels. Panel 112 may be coupled to housings 104, 106, first assembly 102 or second assembly 110. Mechanisms for coupling panel 112 include a slot, hinge, compartment, hook and latch fastener, clips, glue, buttons, buckles, snaps, screws, etc. Second assembly 110 contains conductive material 118 that allows the data disk reader 114 to communicate with speaker(s) 120, 122. Additionally, conductive material 118 may provide power from a power source 124 and an optional power source 126 to controls 116 and/or data disk reader 114. It should be recognized that power source 124 and power source 126 may be placed in the same housing. Alternatively, a single power source may be used and may be placed on panel 112. Volume controls 128 are shown on first housing 104, and communicate with data disk reader 114 through conductive material 118. It should be recognized that volume controls 128 may be placed on housings 104, 106, panel 112 or on a second panel coupled to assembly 102 or 110.

FIG. 5 displays a third embodiment of a headset 200. This embodiment includes: an assembly 202, a housing 204 coupled to a first end 206 and second end 208 of assembly 202. Housing 204 is shown coupled to assembly 202 using hinges 209, allowing for the independent movement of housing 204 and assembly 202. A speaker 210 is located within housing 204. Assembly 202 is formed to secure headset 200 to the ear of a user and placing speaker 210 over the ear. A panel 212 is shown coupled to housing 204 using two screws 214. Panel 212 includes a data disk reader 216 which communicates with speaker 210. Mechanisms for coupling panel 212 include a slot, hinge, compartment, hook and latch fastener, clips, glue, buttons, buckles, snaps, screws, etc. Power source 218 is shown as part of panel 212. Power source 218 provides power to data disk reader 216. Controls for controlling the operation of the data disk reader 216 are remote from the headset 200.

In the above embodiments, housings 16, 20, 104, 106 and 204 are made from the same material, e.g., a form of polyurethane, polyethylene, etc. Of course, other synthetic and natural materials having similar structural characteristics may also be utilized if desired.

With regard to the data disk holder described above, it should be recognized that a door may be used to protect the data disk, e.g., hinged door assembly, retractable door system, etc. Additionally, it should be recognized that the data disk is smaller than a CD, and data disks of sizes other than that shown are possible. With regard to the data disk, any portable, removable data storage means now known or later developed can be used in conjunction with the present invention.

B. Headset with Data Disk Player and Display

The current invention provides a headset video data disk player. The headset includes a data disk reader in communication with a display for presenting video to a user.

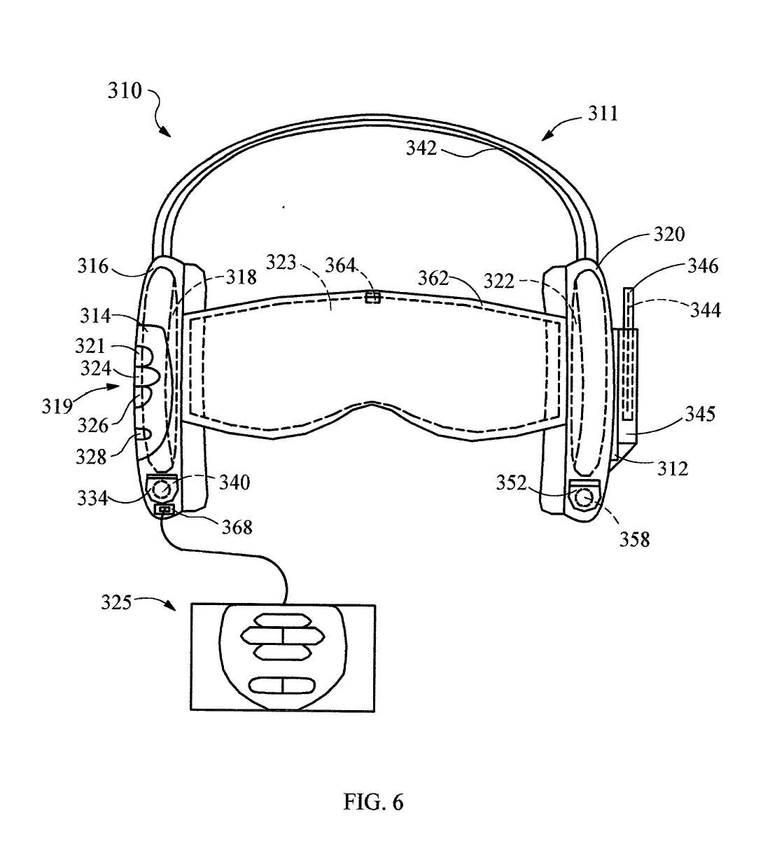

Turning to FIG. 6, a front view of a headset 310 is shown. Headset 310 is shown including a head assembly 311, a data disk reader 312, a control panel 314, speakers 318, 322 and a display 323. Head assembly 311 secures headset 310 to the head of a user. Control panel 314 provides an interface for operating data disk reader 312. Data disk reader 312 is configured to read the contents of a data disk. Data disk reader is shown in communication with speakers 318, 322 for converting the data read by data disk reader 312 into sound and display 323 for displaying the data read by data disk reader 312.

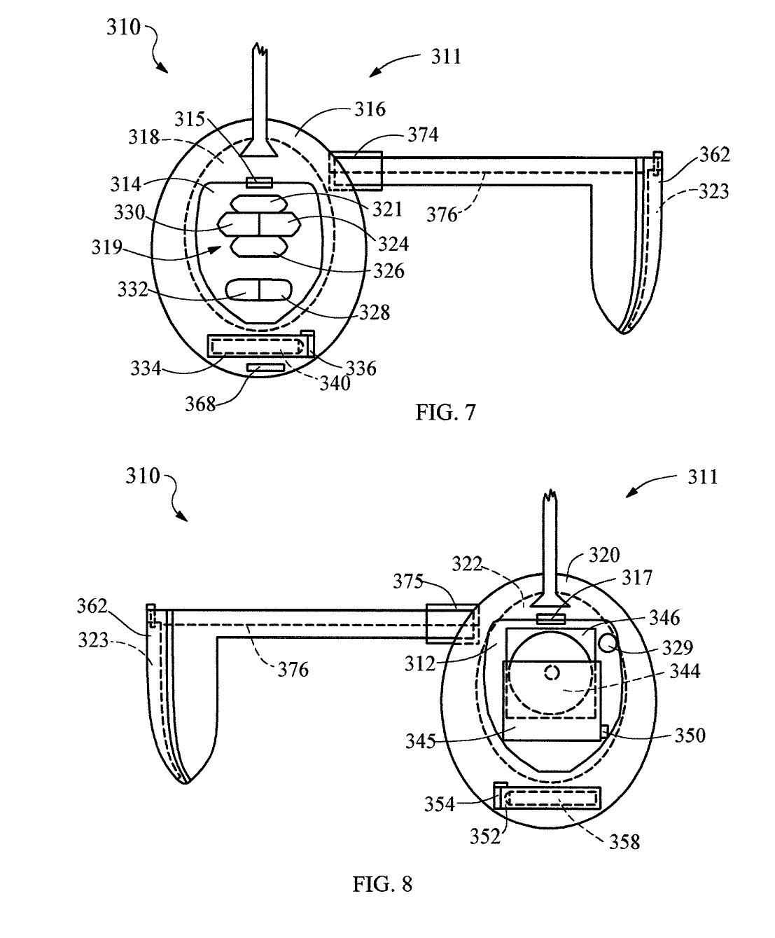

According to one aspect of the invention, as shown in FIGS. 6-8, control panel 314 is shown coupled to a housing 316 of head assembly 311 using a control panel coupler 315 (FIG. 7). Control panel 314 is shown including controls 317 which include input devices 321, 324, 326, 330. Input devices 328, 332 are also shown on control panel 314. Together, input devices 321, 324, 326, 328, 330 and 332 provide an interface for control panel 314 allowing a user to control the operation of data disk reader 312 and/or display 323. For example, input devices 328, 332 can control the volume of sound emitted from speakers 318, 322 and/or the display settings for display 323, e.g., size, shape, orientation, color, tint, contrast, brightness, etc. Control panel 314 may include all or some of input devices 321, 324, 326, 328, 330 and 332 depending on the desired functionality. Additionally, control panel 314 may include additional input devices for controlling data disk reader 312 and/or display 323. Alternatively, display 323 can be controlled using a separate control panel or based on the current operation of data disk reader 312 without any additional input devices.

Data disk reader 312 is shown coupled to a housing 320 of head assembly 311 using a data disk coupler 317. Data disk reader 312 can include a data disk compartment 345. Data disk compartment 345 is shown formed on a side of data disk reader 312. A data disk 344 is shown partially inserted into data disk compartment 345. Data disk 344 may be placed in a data disk holder 346 to protect data disk 344 from damage. A locking tab 350 can hold data disk 344 (data disk holder 346) in place for operation. When a user desires to remove data disk 344 (data disk holder 346), locking tab 350 may be pressed and data disk 344 (data disk holder 346) is released. It should be recognized, however, that other locking mechanisms now known or later developed may be used to secure and release data disk 344, e.g., a hinged or retractable door system, etc.

FIGS. 7 and 8 show a display housing 362 of head assembly 311 coupled to housings 316, 320 using display housing couplers 374, 375, respectively. In FIG. 6, display 323 is shown coupled to display housing 362 using display coupler 364. Display 323 can be any type of display now known or later developed, including, for example, a liquid crystal display (LCD), a plasma display, etc. Display housing couplers 374, 375 and/or display coupler 364 can allow display housing 362 and/or display 323 to be adjusted up, down, out and/or in to allow for optimum viewing for a particular user and varying sizes of the heads of users.

It should be recognized that control panel 314, data disk reader 312 and/or display 323 may be permanently or detachably coupled to any part of head assembly 311, including, for example, housings 316, 320 and display housing 362. Numerous mechanisms for coupling control panel 314, data disk reader 312 and/or display 323 are possible, including a slot, hinge, compartment, hook and latch fasteners, clips, glue, buttons, buckles, snaps, screws, etc.

Housings 316, 320 are shown having speakers 318, 322, respectively, coupled thereto. Housings 316, 320 can hold speakers 318, 322 near the ear of a user to facilitate comfortable listening during use. Alternatively, speakers 318, 322 can be sufficiently small to be inserted into the outer ear of a user. While two speakers 318, 320 are shown, it should be recognized that headset 310 can include no speakers, a single speaker or more than two speakers.

Housings 316, 320 are also shown having power compartments 334, 352, respectively. Hinged doors 336, 354 can provide a user access to power compartments 334, 352. It is recognized, however, that other door mechanisms now known or later developed can be used instead of hinged doors 336, 354 including, for example, a retractable door system, a detachable door, etc. Power sources 340, 358 are shown placed within respective power compartments 334, 352. Power sources 340, 358 can provide power to data disk reader 312, control panel 314 and/or display 323. Power sources 340, 358 maybe a dry cell type of power source, however, other power sources 340, 358 now known or later developed can be used, e.g., corded adaptor plugins, solar cells, fuel cells, nuclear capsules, etc. It should be recognized that fewer or additional power sources 340, 358 may be used. Additionally, the one or more power sources 340, 358 can be located anywhere on headset 310 including, for example, within data disk reader 312, control panel 314, head assembly 311, display housing 362, etc.

A data transfer port 368 can also be included on headset 310. In FIGS. 6 and 7, data transfer port 368 is shown on housing 316, however it should be recognized that data transfer port 368 can be located anywhere on headset 310. Data transfer port 368 can be any coupling device capable of transferring data, e.g., a Universal Serial Bus (USB) port, a cannon plug type device, a cable jack, a phone jack, an ethernet port, an infrared transmitter/receiver, etc. Data transfer port 368 can be used to allow an external device 325 to communicate with display 323 and/or speakers 318, 322. Additionally, data transfer port 368 can allow external device 325 to control display 323 and/or data disk reader 312. For example, external device 325 can be a video game controller. Data transfer port 368 can allow a user to play a video game on data disk 344 using the video game controller, display 323, and/or speakers 318, 322.

A sensor 329 can also be included on headset 310. In FIG. 8, sensor 329 is shown on data disk reader 312, however, it should be recognized that sensor 329 can be located anywhere on headset 310. Additionally, more than one sensor 329 can be used and located at various positions on headset 310. Sensor 329 can be, for example, an infrared sensor that detects infrared signals and communicates them to data disk reader 312 and/or display 323 thereby allowing an external device to communicate with and control data disk reader 312 and/or display 323 by emitting infrared signals. It should be recognized that sensor 329 can detect any type of signal, including, infrared, ultra-high frequency (UHF), very high frequency (VHF), etc.

As shown in FIGS. 6-8, head assembly 311 includes housings 316, 320 and display housing 362. Display housing 362 is shown coupled to housings 316, 320. In FIG. 6, head assembly 311 is shown including conductive material 342. Additionally, display housing 362 is shown including conductive material 376 (FIGS. 7 and 8). Conductive material 342, 376 can be used to transmit data between data disk reader 312, control panel 314, speaker(s) 318, 322, and/or display 323. Conductive material 342, 376 may comprise copper wire, ceramic material, etc. Data disk reader 312, control panel 314, speaker(s) 318, 322, and/or display 323 can either be directly connected to conductive material 342, 376, or conductive material 342, 376 may be connected to similar conductive material within housings 316, 320, which then connects to data disk reader 312, control panel 314, speaker(s) 318, 322 and/or display 323. While conductive material 342, 376 is shown, it should be recognized that other materials and transmitting devices now known or later developed can be utilized, e.g., infrared sensors, fiber optics, lasers, etc.

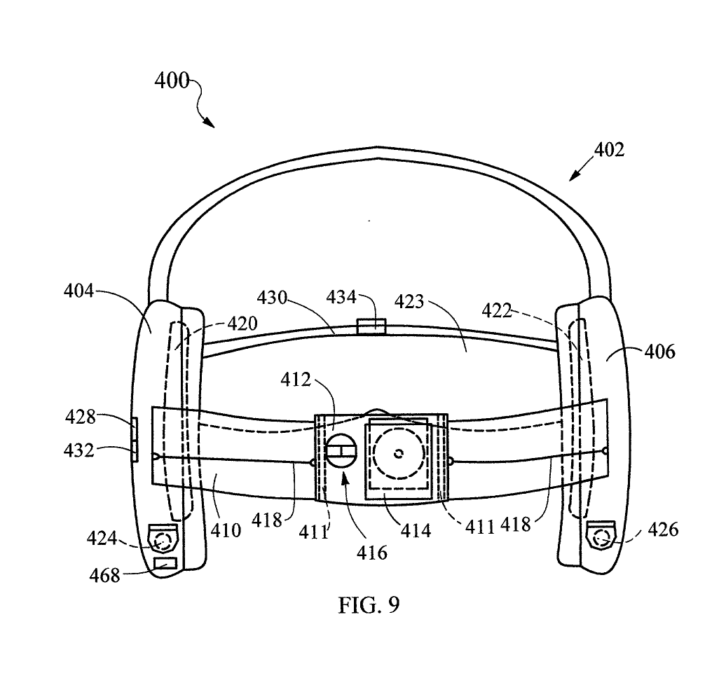

Turning to FIG. 9, a rear view of a headset 400 is shown. Headset 400 includes head assembly 402 which includes a first housing 404 having a speaker 420, input devices 428, 432 and a data transfer port 468, a second housing 406 having a speaker 422, and a display housing 430 having a display 423. Each is configured substantially the same as described above.

Head assembly 402 also includes a separate control housing 410 shown coupled to first housing 404 and second housing 406. Panel 412 is shown coupled to control housing 410 using coupler 411. Controls 416 and data disk reader 414 are shown coupled to panel 412. Control housing 410 is shown having conductive material 418 which allows controls 416 and data disk reader 414 to communicate with speakers 420, 422, data transfer port 468, display 423 and/or input devices 428, 432. Additionally, conductive material 418 may also provide power to controls 416 and/or data disk reader 414 from power sources 424, 426 shown coupled to housings 404, 406, respectively.

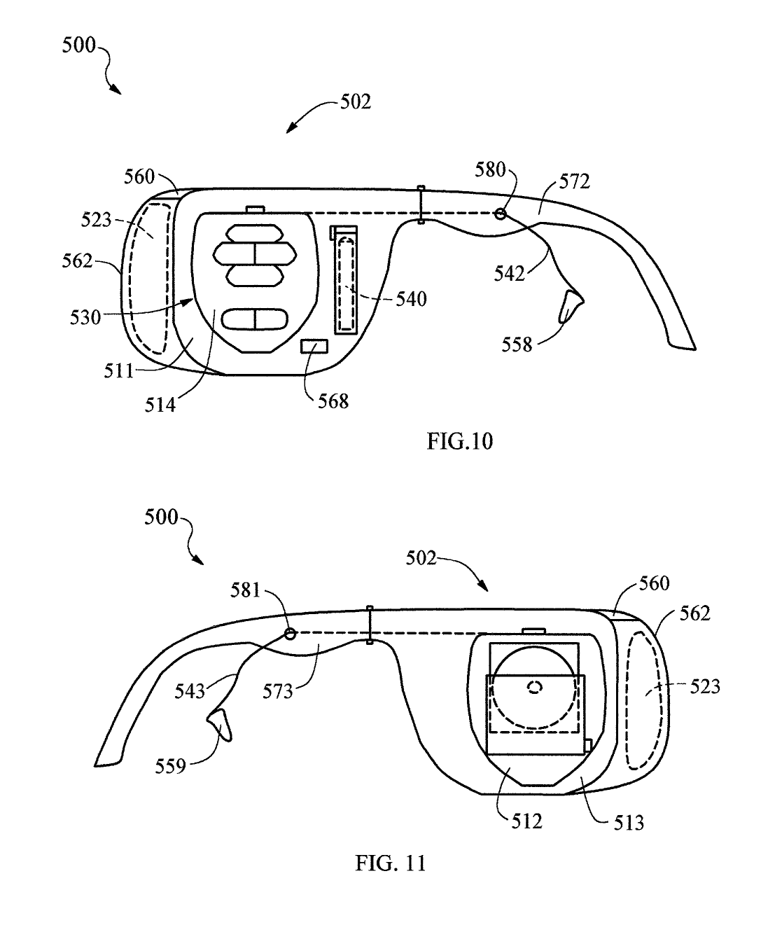

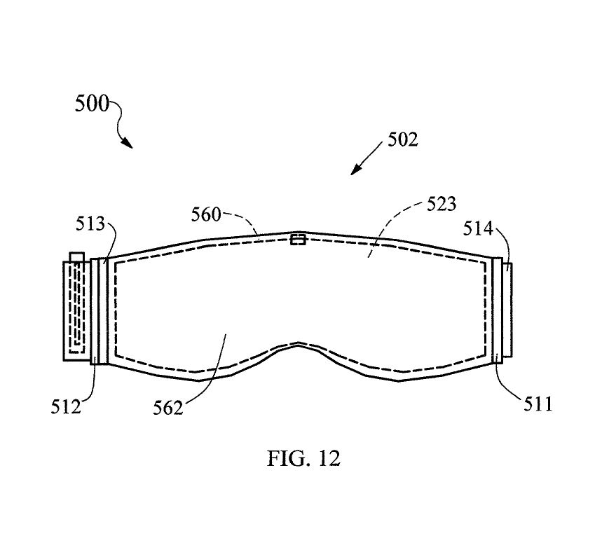

FIGS. 10-12 show a front and two side views of a headset 500. Headset 500 is shown including a head assembly 502 which includes a display housing 562 coupled to a first housing 511 and a second housing 513. Head assembly 502 is configured to secure headset 500 to a user's head in a similar fashion as eye glasses. Head assembly 502 is shown further including a first support 572 and a second support 573 coupled to housings 511, 513, respectively. An additional assembly 560 can be included in head assembly 502 and attached to each of display housing 562 and housings 511, 513 to add stability to headset 500. Alternatively, a display 523 can be coupled to first support 572 and second support 573 without use of display housing 562.

Display housing 562 is shown having display 523 coupled thereto. Data disk reader 512 is shown coupled to second housing 513 and is in communication with display 523 and controls 530. Controls 530 are shown on control panel 514 which is shown coupled to first housing 511. Headset 500 is also shown having a data transfer port 568 and a power source 540 located on housing 511. While shown as separate housings, it should be recognized that display housing 562 and housings 511, 513 can comprise a single contiguous housing having display 523, control panel 514, and/or data disk reader 512 coupled thereto.

Data disk reader 512 communicates with speakers 558, 559 using conductive material 542, 543, respectively. Supports 572, 573 can place respective speakers 558, 559 next to an ear of a user. For example, supports 572, 573 are shown having openings 580, 581, respectively. Openings 580, 581 allow conductive material 542, 543 to pass through and connect to speakers 558, 559. This configuration allows speakers 558, 559 to be placed within the outer portion of the ear of a user during use while keeping speakers 558, 559 coupled to headset 500.

Supports 572, 573 are formed to fit over the ears of a user to secure headset 500 to the head of a user. It should be recognized that supports 572, 573 can be attached to housing 511, 513 using any mechanism as described above. Supports 572, 573 may be configured to allow a user to adjust their length to allow supports 572, 573 to rest comfortably. Alternatively, each support 572, 573 and housing 511, 513 pair can comprise a single contiguous structure.

Headsets 400, 500 operate in substantially the same manner as described above with reference to headset 310 shown in FIGS. 6-8. It should be recognized that the location and inclusion of the various parts shown on each exemplary headset 310, 400, 500 is for exemplary purposes only and numerous variations including all or some of these parts are possible and covered under the invention.

Each of the housings and assemblies described herein can be made from a variety of synthetic and/or natural materials. Appropriate materials include, for example, polypropylene, polyethylene, graphite, etc. Other materials with similar structural and weight characteristics can be utilized. Additionally, while a particular data disk size is depicted, data disks of varying sizes are possible. The data disk size depicted is only exemplary of the possible sizes and is not intended to be limiting. It should be recognized that a data disk can store and a data disk reader can read any data format now known or later developed, including a compact disk (CD), a digital versatile disk (DVD), a data play disk, etc. Also, the data disk reader is not limited to reading only video data, but can include the ability to read any type of data, including, for example, audio data. Additionally, it is evident that data disk reader can include additional functionality other than reading data disks, including, for example, recording data disks.

As illustrated, the various aspects of the invention depict headsets that are portable and adapted to be secured to the head/neck area of a user. It should be noted that some or all of the housings/assemblies as well as the particular shapes shown and described herein are not required to implement the invention. The invention applies equally to alternative embodiments of portable electronic devices.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A headset comprising:
a head assembly for securing to the head of a user;
a display coupled to the head assembly; and
a data disk reader coupled to the head assembly and in communication with the display.

2. The headset of claim 1, further comprising a power source for the data disk reader and the display.

3. The headset of claim 1, further comprising at least one speaker coupled to the head assembly, wherein the data disk reader is further in communication with the at least one speaker.

4. The headset of claim 3, wherein the at least one speaker is coupled to a housing of the head assembly.

5. The headset of claim 1, wherein the display is coupled to a housing of the head assembly.

6. The headset of claim 1, wherein the data disk reader is coupled to a housing of the head assembly.

7. The headset of claim 1, further comprising a sensor for receiving signals for controlling at least one of the data disk reader and the display.

8. The headset of claim 1, further comprising a control panel for controlling at least one of the data disk reader and the display.

9. The headset of claim 8, wherein the control panel is coupled to the head assembly.

10. The headset of claim 1, further comprising a data transfer port located on the head assembly.

11. The headset of claim 10, wherein the data transfer port allows an external device to communicate with the display.

12. The headset of claim 10, wherein the data transfer port allows an external device to control at least one of the data disk reader and the display.

13. A headset comprising:
a head assembly for securing to the head of a user, the head assembly including a first housing, a second housing, and a display housing;
a first speaker coupled to the first housing;
a second speaker coupled to the second housing;
a display coupled to the display housing; and
a data disk reader coupled to the head assembly, wherein the data disk reader is in communication with the first speaker, the second speaker and the display.

14. The headset of claim 13, further comprising at least one power source to provide power to the data disk reader and the display.

15. The headset of claim 13, further comprising a sensor for receiving signals for controlling at least one of the data disk reader and the display.

16. The headset of claim 13, further comprising a control panel for controlling at least one of the data disk reader and the display, wherein the control panel is coupled to the head assembly.

17. A headset comprising:
a head assembly for securing to the head of a user, the head assembly including a first support for placing a first speaker next to a first ear of a user and a second support for placing second speaker next to a second ear of a user;
a display coupled to the first support and the second support; and
a data disk reader coupled to the head assembly, wherein the data disk reader is in communication with the first speaker, the second speaker and the display.

18. The headset of claim 17, further comprising a control panel for controlling at least one of the data disk reader and the display, wherein the control panel is coupled to the head assembly.

19. A headset comprising:
means for securing to a head of a user;
means for reading a data disk coupled to the means for securing; and
means for displaying data read by the means for reading coupled to the means for securing.

20. The headset of claim 19, further comprising means for converting data read by the means for reading into sound.

21. The headset of claim 19, further comprising means for controlling the means for reading.
